(19) United States
(12) Patent Application Publication
(10) Pub. No.: US 2024/0153280 A1
(43) Pub. Date: May 9, 2024

(54) METHOD, APPARATUS, COMPUTER DEVICE AND MEDIUM OF OBJECT DETECTION FOR DRIVING ASSISTANCE

(71) Applicant: Black Sesame Technologies Co., Ltd., Wuhan (CN)

(72) Inventor: Hao Sun, Wuhan (CN)

(21) Appl. No.: 18/503,080

(22) Filed: Nov. 6, 2023

(30) Foreign Application Priority Data
Nov. 9, 2022 (CN) 202211400000.1

(51) Int. Cl. G06V 20/58

(52) U.S. Cl. CPC G06V 20/58

(57) ABSTRACT

A method of object detection for driving assistance, including: acquiring a driving scene video, and acquiring a driving scene image of each moment of the driving scene video; determining a plurality of non-overlapping basic candidate bounding boxes on the driving scene image; determining a region of interest of the driving scene image; determining a plurality of expanded candidate bounding boxes with different dimensions near each of the basic candidate bounding boxes in the region of interest; and inputting the basic candidate bounding boxes and the expanded candidate bounding box into an object detection model to detect an object affecting a driving behavior, and obtaining an object detection result of the driving scene image.

### CROSS-REFERENCE TO RELATED APPLICATION

This application claims the benefit under 35 U.S.C. § 119(a) of the filing date of Chinese Patent Application No. 202211400000.1, filed in the Chinese patent office on Nov. 9, 2022. The disclosure of the foregoing application is herein incorporated by reference in its entirety.

### TECHNICAL FIELD

The present document relates to the field of intelligent driving technologies, and in particular, to a method, an apparatus, a computer device and a medium of object detection for driving assistance.

### BACKGROUND

In the field of intelligent driving, a concept of vehicle-to-everything (V2X) is widely concerned. An object detection is a base of the vehicle-to-everything, and various road events and traffic flow estimation are very dependent on a result of the object detection. Generally, a driving scene is photographed by using a plurality of cameras, and an object detection is performed on a photographed video to realize a vehicle-to-everything, and an object detection model in the vehicle-to-everything needs to detect a location and a state of an object which a vehicle within a certain range (for example, 0 to 400 meters) needs to pay attention to during driving.

A location and a state of an object within a certain distance of a vehicle are required to be informed in a vehicle-to-everything, so an object detection in the vehicle-to-everything is very concerned for objects at a far end and a near end. Objects at a far end in a visual field of a camera are relatively small in dimensions and densely distributed, so a detection accuracy requirement of an object detection model is relatively high.

### SUMMARY

The described techniques provides a method, an apparatus, a computer device and a medium of object detection for driving assistance.

A first aspect of the described techniques relates to a method of object detection for driving assistance, including: acquiring a driving scene video, and acquiring a driving scene image of each moment of the driving scene video; determining a plurality of non-overlapping basic candidate bounding boxes on the driving scene image; determining a region of interest of the driving scene image; determining a plurality of expanded candidate bounding boxes with different dimensions near each of the basic candidate bounding boxes in the region of interest; and inputting the basic candidate bounding boxes and the expanded candidate bounding boxes into an object detection model to detect an object affecting a driving behavior, and obtaining an object detection result of the driving scene image.

In an embodiment, the method of object detection for driving assistance according to the described techniques further includes: based on an object detection result of a driving scene image of a current moment, predicting a region of interest of a next moment, and updating the region of interest with the predicted region of interest of the next moment.

In one embodiment, determining the region of interest of the driving scene image comprises: acquiring a pre-designated region as the region of interest.

In one embodiment, determining the region of interest of the driving scene image comprises: determining a small object dense region in the driving scene image as the region of interest, wherein the small object dense region is a region in which an object has a dimension smaller than a predetermined dimension threshold or a density greater than a predetermined density threshold in the driving scene image.

In an embodiment, determining the small object dense region in the driving scene image as the region of interest comprises: inputting basic candidate bounding boxes of a driving scene image of an initial moment of the driving scene video into the object detection model to detect the object, and obtaining an object detection result of the initial moment; and determining the small object dense region as the region of interest based on the object detection result of the initial moment.

In one embodiment, determining the plurality of non-overlapping basic candidate bounding boxes on the driving scene image comprises: determining a square basic candidate bounding box, wherein a side length of the basic candidate bounding box is S, and S is 2^{x} times of a down-sampling multiple of the object detection model, wherein x is an integer; determining the plurality of expanded candidate bounding boxes with different dimensions near each of the basic candidate bounding boxes in the region of interest includes: determining a plurality of first expanded candidate bounding boxes in a vicinity of each of the basic candidate bounding boxes, wherein the first expanded candidate bounding boxes include a plurality of rectangles having a side length of a positive integer multiple of S, and a center of the plurality of first expanded candidate bounding boxes coincides with a center of the basic candidate bounding box, and by translating in a plurality of directions the plurality of first expanded candidate bounding boxes together with the basic candidate bounding box on the driving scene image, determining a plurality of second expanded candidate bounding boxes.

In an embodiment, prior to inputting the basic candidate bounding boxes and the expanded candidate bounding boxes into the object detection model to detect the object affecting the driving behavior, the method of object detection for driving assistance according to the described techniques further includes: acquiring a sample image; determining a plurality of non-overlapping basic candidate bounding boxes on the sample image, and determining a plurality of expanded candidate bounding boxes with different dimensions near each of the basic candidate bounding boxes; randomly reserving a part of candidate bounding boxes in the basic candidate bounding boxes and the expanded candidate bounding boxes to obtain a plurality of reserved candidate bounding boxes; and inputting the reserved candidate bounding boxes into the object detection model for training.

In one embodiment, determining the plurality of non-overlapping basic candidate bounding boxes on the sample image, and determining the plurality of expanded candidate bounding boxes with different dimensions near each of the basic candidate bounding boxes, comprises: determining a square basic candidate bounding box, wherein a side length of the basic candidate bounding box is S, and S is 2^{x} times of a down-sampling multiple of the object detection model, wherein x is an integer; determining a plurality of first expanded candidate bounding boxes in a vicinity of each of the basic candidate bounding boxes, wherein the first expanded candidate bounding boxes include a plurality of rectangles having a side length of a positive integer multiple of S, and a center of the plurality of first expanded candidate bounding boxes overlap with a center of the basic candidate bounding box, and determining a plurality of second expanded candidate bounding boxes by translating the plurality of first expanded candidate bounding boxes together with the basic candidate bounding box in a plurality of directions on the sample image.

In one embodiment, randomly reserving the part of candidate bounding boxes in the basic candidate bounding boxes and the expanded candidate bounding boxes to obtain the plurality of reserved candidate bounding boxes, includes one or more of following steps: randomly selecting one or more region(s) in the sample image as reserved region(s), and reserving only candidate bounding boxes located in the reserved region(s) as the reserved candidate bounding boxes; randomly reserving a certain proportion of candidate bounding boxes in all of the basic candidate bounding boxes and the expanded candidate bounding boxes as the reserved candidate bounding boxes; and selecting a candidate bounding box of a certain dimension as the reserved candidate bounding box from the basic candidate bounding box and the expanded candidate bounding box; or selecting a candidate bounding box located at a particular location relative to the basic candidate bounding box as the reserved candidate bounding box.

In an embodiment, the method of object detection for driving assistance according to the described techniques further includes: increasing a convolution layer number of a feature extraction network in the object detection model.

According to the method of object detection for driving assistance of the described techniques, for a region of interest which is a region needing a special attention in a driving scene, laying more candidate bounding boxes with more various dimensions is beneficial for improving an object detection precision of the region of interest; meanwhile, excessive candidate bounding boxes are prevented from being added to a whole region of the image to be detected, and therefore a calculation amount of the object detection model is reduced, and an object detection speed is improved. On the other hand, in a process of training an object detection model, in order to avoid that too many candidate bounding boxes are laid on a sample image to lead to excessive negative samples in the training process and thus to cause a detection precision reduction of the model, the candidate bounding boxes are randomly discarded while only a part thereof are reserved for training the object detection model, so that a detection stability of the object detection model may be improved, and a detection precision may be ensured at the same time.

According to a second aspect of the described techniques, there is provided an apparatus of object detection for driving assistance, comprising: an acquisition module configured for acquiring a driving assistance video of an object to be detected, and acquiring an image to be detected of each moment of the driving assistance video; a determination module configured for determining a plurality of non-overlapping basic candidate bounding boxes on the image to be detected, and determining a region of interest of the image to be detected, and determining a plurality of expanded candidate bounding boxes with different dimensions near each of the basic candidate bounding boxes in the region of interest; and a detection module configured for inputting the basic candidate bounding boxes and the expanded candidate bounding boxes into an object detection model for object detection, to obtain an object detection result of the image to be detected.

According to a third aspect of the described techniques, there is provided a computer device comprising a memory and a processor, the memory stores thereon a computer program, and the processor, when executing the computer program, implements the method of object detection for driving assistance according to the first aspect of the described techniques.

According to a fourth aspect of the described techniques, there is provided a computer-readable storage medium storing thereon a computer program, which, when executed by a processor, implements the method of object detection for driving assistance according to the first aspect of the present application.

Details of one or more embodiments of the instant application are set forth in accompanying drawings and descriptions below. Other features, objects, and advantages of the described techniques will become apparent from the specification, drawings, and claims.

### BRIEF DESCRIPTION OF THE DRAWINGS

FIG. 1 is a flowchart of a method of object detection for driving assistance according to an embodiment of the described techniques;

FIG. 2 is a schematic diagram of basic candidate bounding box determination according to an embodiment of the application;

FIG. 3 is a flowchart of a method of object detection for driving assistance according to an embodiment of the described techniques;

FIGS. 4A and 4B are schematic diagrams of Intersection over Union calculations according to embodiments of the described techniques;

FIG. 5 is a flowchart of a method of object detection for driving assistance according to an embodiment of the described techniques;

FIG. 6 is a schematic diagram of basic candidate bounding box determination according to an embodiment of the described techniques;

FIG. 7 is a schematic diagram of basic candidate bounding box determination according to an embodiment of the described techniques;

FIG. 8 is a flowchart of a method of object detection for driving assistance according to an embodiment of the described techniques;

FIG. 9 is a schematic diagram of an apparatus of object detection for driving assistance according to an embodiment of the described techniques;

FIG. 10 is a schematic diagram of an apparatus of object detection for driving assistance according to an embodiment of the described techniques;

FIG. 11 is a schematic diagram of an apparatus of object detection for driving assistance according to an embodiment of the described techniques;

FIG. 12 is a schematic diagram of an apparatus of object detection for driving assistance according to an embodiment of the described techniques; and

FIG. 13 is a schematic diagram of a computer device according to an embodiment of the described techniques.

### DETAILED DESCRIPTION

In vehicle-to-everything (V2X) applications, vehicles wish to detect locations and states of objects in certain ranges in driving scenes thereof. In the described techniques, an object to be detected is, for example, an object that needs attention in a driving scene, an object that may affect a driving behavior, and the like. An object to be detected is such as a location and a moving state of a nearby object (such as a vehicle, a pedestrian, and the like) of a vehicle, a location and a state of a traffic light ahead, and the like. Locations and states of these objects will affect driving behaviors and decisions of vehicles. For this reason, an object detection is generally performed on a photographed driving scene video using an object detection model. An accuracy and a stability degree of an object detection result are particularly important.

An object detection model is a deep learning based neural network model for detecting a location and a state of an object in an inputted video or image. In a process of detecting an image to be detected by using an object detection model, a plurality of candidate bounding boxes are laid on an inputted image, and the object detection model determines a location and a state of an object by determining whether an Intersection over Unit (IOU) between each candidate bounding box and a ground truth bounding box is greater than a preset threshold. Therefore, laying more candidate bounding boxes on an image to be detected helps to obtain more output boxes with an IOU greater than the threshold, thereby obtaining a more stable output result. However, if too many candidate bounding boxes are laid on an image to be detected, a calculation amount of the model is increased, a processing speed is reduced, and a real-time detection of the driving scene is seriously affected, which are very unfavorable in an application of vehicle-to-everything.

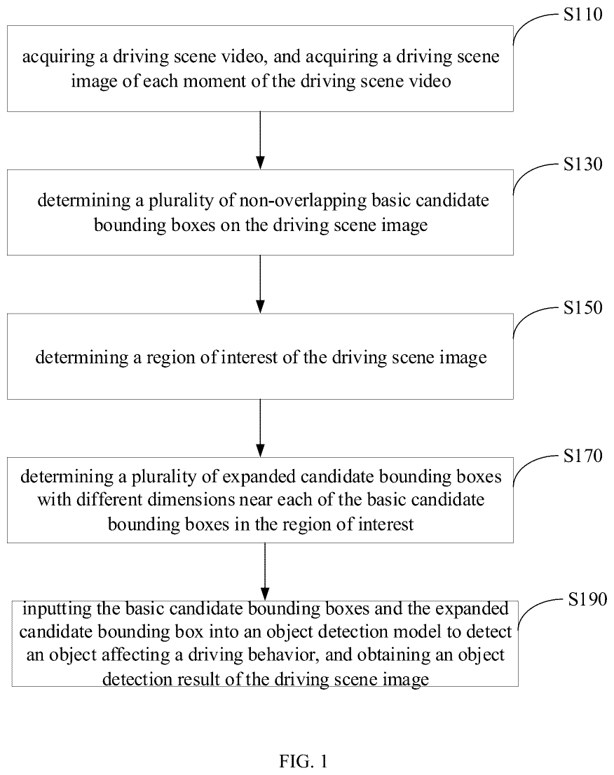

Referring to FIG. 1, a method of object detection for driving assistance according to the described techniques includes following steps S110 to S190.

S110: acquiring a driving scene video, and acquiring a driving scene image of each moment of the driving scene video.

The driving scene video may be a video of a scene outside a vehicle captured in real time by a camera mounted on the vehicle, or may be a road video captured in real time by a camera movably or fixedly installed on a road. The driving scene video is a video to be subjected to an object detection, and more specifically, is a video of an object to be detected, which affects a driving behavior. The driving scene image of each moment of the driving scene video is, for example, an image of each frame or an image acquired every several frames in the driving scene video. The driving scene image is, for example, an image acquired from a driving scene video in chronological order. The driving scene image includes, for example, a road in a driving scene of a vehicle, an object on the road, and the like.

S130: determining a plurality of non-overlapping basic candidate bounding boxes on the driving scene image.

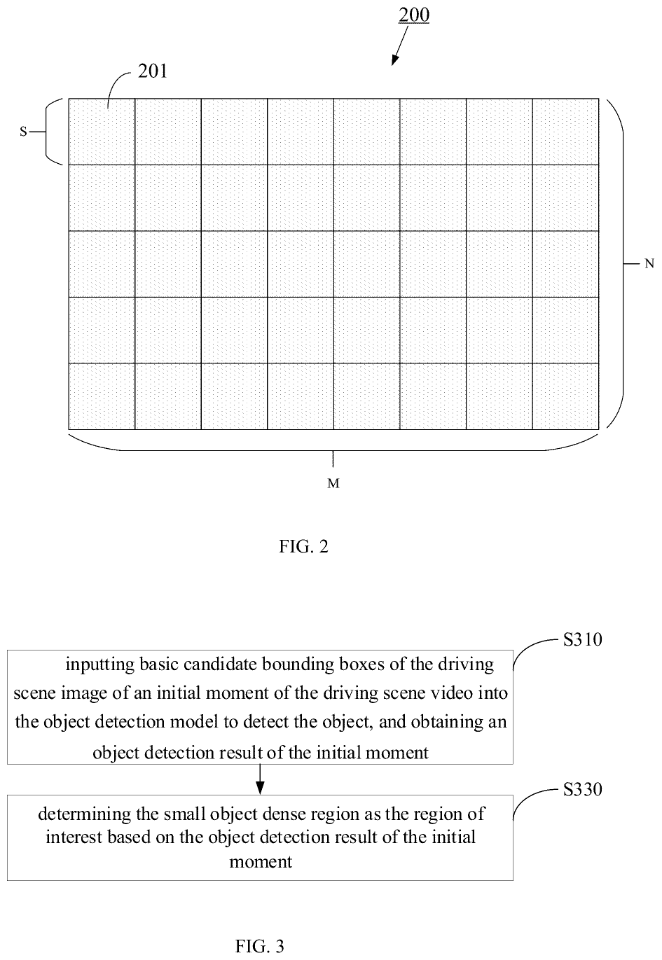

Further referring to FIG. 2, on a driving scene image 200, 8×5 mutually non-overlapping basic candidate bounding boxes 201 are laid. In the example of FIG. 2, the plurality of basic candidate bounding boxes 201 collectively completely cover the entire driving scene image 200. It should be appreciated that in other embodiments, the plurality of basic candidate bounding boxes 201 may cover only a portion of the driving scene image 200.

A size or a number of the basic candidate bounding boxes 201 may be changed as needed. In some embodiments, the size and the number of the candidate bounding boxes are determined according to a size of a sample image. For example, a square basic candidate bounding box 201 is determined, and a side length of the basic candidate bounding box 201 is S (e.g., S pixels). In the example shown in FIG. 2, the driving scene image 200 is of a size of M×N pixels, and

$$\frac{M}{S} \times \frac{N}{S}$$

basic candidate bounding boxes will be determined, wherein S is a common divisor of M and N. Illustratively, S is an integer power multiple of 2, i.e., 2^{x} times, wherein x is an integer, of a down-sampling multiple of an object detection model used for an object detection of the driving scene image. An integer here may include a positive integer, a negative integer, and 0. For example, an integer power of 2 is, for example, 0.25, 0.5, 1, or 2, etc. For example, S is 0.25 times, 0.5 times, 1 time, 2 times, or the like of a down-sampling multiple of an object detection model.

S150: determining a region of interest of the driving scene image.

The region of interest is a region where an object detection is important to detect an object affecting a driving behavior in the driving scene image. For example, the region of interest is a region that needs a special attention in a driving scene in a vehicle road system, and thus needs an object detection with a higher accuracy. In other words, for the region of interest, an algorithm of an object detection model will need a higher accuracy and the object detection model will allocate a greater amount of calculation for the region of interest. In an embodiment, an area of a region of interest should be smaller than an area of an entire driving scene image, i.e., the region of interest is a part of the driving scene image.

In one embodiment, determining the region of interest of the driving scene image, comprises: acquiring a pre-designated region as the region of interest. For example, the region of interest is a region manually designated by a user. In this case, a driving scene video and accordingly a driving scene image may be displayed on a display screen, which is, for example, a touch display screen, and a region inside a selected polygon may be designated as a region of interest by a user on the display screen by manually selecting the polygon. In this case, the user may select the region of interest according to his/her own needs. For example, in a driving scene video taken from an intersection, a content to be paid attention to for the driving scene is generally the state of an intersection traffic light. Accordingly, the user may manually select a region of the traffic light in the driving scene video as a region of interest.

In another embodiment, determining the region of interest of the driving scene image, includes: determining a small object dense region in the driving scene image as the region of interest. The small object dense region is a region in which an object has a dimension smaller than a predetermined dimension threshold or a density greater than a predetermined density threshold in the driving scene image.

In a driving scene image, because an object at a far end of a visual field has a relatively small dimension, if the object is detected by using a common calculation amount and precision, the detection result will be very unstable, and the detection result of the small-dimension object at the far end of the visual field is very inaccurate. A relatively small dimension may be understood as the object to be detected covering a relatively small area of the image to be detected. Similarly, if a density of an object is large in a visual field of a driving scene image, in other words, a number of the objects in a unit region is greater than a predetermined density threshold, that is, the objects are densely distributed in a certain region, a detection thereof using an ordinary calculation amount and accuracy will also cause the detection result to be very unstable, and a detection result of the densely distributed objects will be very inaccurate. Therefore, it is necessary to determine a small object dense region as a region of interest and detect it using a higher-precision algorithm. Illustratively, in a driving scene image, a region of interest is usually a far-end region in a visual field, according to imaging characteristics of cameras.

With further reference to FIG. 3, in some embodiments, determining the small object dense region in the driving scene image as the region of interest, includes following steps S310-S330.

S310: inputting basic candidate bounding boxes of a driving scene image of an initial moment of the driving scene video into the object detection model to detect the object, and obtaining an object detection result of the initial moment.

It should be understood that a segment of a driving scene video includes driving scene images of multiple moments, and the driving scene image of the initial moment is an image of a starting moment (e.g., a first frame or first few frames in the video) in the segment of the driving scene video. Selecting basic candidate bounding boxes from the driving scene image of the initial moment by using the above method, and inputting the selected basic candidate bounding boxes into an object detection model for object detection, an object detection result obtained at this time is the detection result of the driving scene image of the initial moment.

S330: determining the small object dense region as the region of interest based on the object detection result of the initial moment.

Since candidate bounding boxes applied to the initial image are relatively few and the basic candidate bounding boxes do not overlap with each other, an accuracy of the detection result obtained for the image may not be very high, but an approximate dimension and location of an object may also be known from the detection result. Based on the result of object detection on the driving scene image of the initial moment, it may be determined which region in the driving scene image has objects with dimensions smaller than a predetermined dimension threshold or has objects with densities greater than a predetermined density threshold, so as to determine a region of interest in the image. The region of interest determined at this time may be understood as an initial region of interest in the process of performing object detection on the driving scene video.

Referring back to FIG. 1, a method of object detection for driving assistance according to the described techniques further includes S170: determining a plurality of expanded candidate bounding boxes with different dimensions near each of the basic candidate bounding boxes in the region of interest.

In a process of detection and inference by using an object detection model, a candidate bounding box will be scaled to obtain a real object region by combining an offset of the object detection model. An IOU is a standard that measures an accuracy of detecting a corresponding object in a particular data set at the time of detection. The IOU calculates an overlap ratio of a “predicted bounding box” and a “true bounding box”. In actual calculations, an IOU is a result of dividing an overlapping portion of two regions by a collective portion of the two regions. A usage of an IOU may be used to determine whether a prediction is correct or incorrect. A common IOU threshold in practice is 0.5. If an IOU is greater than 0.5, the box is considered a correct box (positive sample), otherwise it is considered an error box (negative sample).

In a process of detection and inference using an object detection model, in movement and scaling, an object to be detected may touch a boundary between positive and negative samples and thus be designated as a negative sample. Therefore, if a number and a density of candidate bounding boxes in an image to be detected are increased, a number of resulting correct boxes will be increased, and thus a detection result will be more stable. However, if more candidate bounding boxes are laid out for an entire region of a driving scene image, a large increase in the candidate bounding boxes will result, an amount of calculation of the model increases, and a processing speed is reduced. On the other hand, a large increase of candidate bounding boxes will also increase a number of output error boxes at the same time, thereby affecting a detection accuracy. This will seriously affect a real-time performance and an accuracy of a driving scene detection, and is very disadvantageous in an application of vehicle-to-everything.

Based on this, according to a solution of an embodiment of the described techniques, expanded candidate bounding boxes are laid only in a region of interest, and for a region outside the region of interest in a driving scene image, an object detection is performed only by using basic candidate bounding boxes, which is helpful for reducing a calculation pressure of an algorithm of an object detection model, thereby improving a calculation speed and an output accuracy. It should be understood that, in embodiments of the described techniques, expanded candidate bounding boxes are determined only in a region of interest, and for a region other than the region of interest in a driving scene image, no expanded candidate bounding box is laid out.

In a specific application, a coverage region of expanded candidate bounding boxes and a coverage region of basic candidate bounding boxes are not completely overlapped, that is, the coverage region of the expanded candidate bounding boxes and the coverage region of the basic candidate bounding boxes may have an overlapping part, but the coverage regions of the expanded candidate bounding boxes and the basic candidate bounding boxes are not completely the same. In addition, dimensions of the plurality of expanded candidate bounding boxes are different, and accordingly the plurality of expanded candidate bounding boxes may cover different areas of driving scene images, and a detection of objects with different dimensions is facilitated. It should be understood that determining a plurality of expanded candidate bounding boxes in a vicinity of each of the basic candidate bounding boxes means there is a portion where there is an overlap between the expanded candidate bounding box and the basic candidate bounding box, for example, a portion where there is an overlap between each expanded candidate bounding box and the basic candidate bounding box, and the plurality of expanded candidate bounding boxes may have portions that overlap with each other. Preferably, an area of each expanded candidate bounding box is not smaller than an area of a basic candidate bounding box.

In some embodiments, determining the plurality of candidate bounding boxes in the region of interest means that all of the region of each expanded candidate bounding box is located within the region of interest, and in other embodiments, determining the plurality of candidate bounding boxes in the region of interest may also mean that a portion of the region of each candidate bounding box is located within the region of interest.

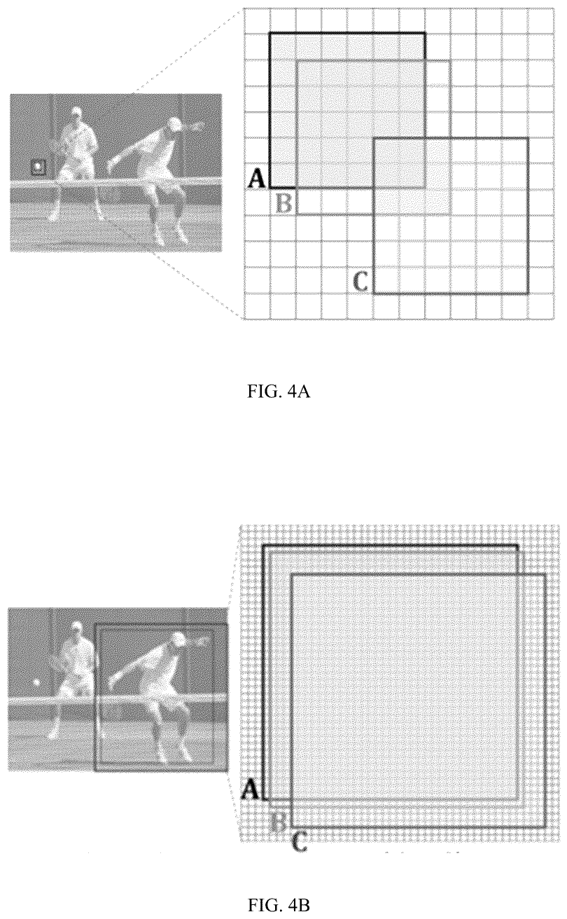

In a specific example, since probabilities of objects of different dimensions touching boundaries of positive and negative samples are different, it is preferable that a small object dense region in a driving scene image be set as a region of interest. Specifically, referring to FIG. 4A, A is used as a ground truth bounding box, B and C are used as a candidate bounding box before moving and a candidate bounding box after moving, respectively, and an object to be detected is an object with a relatively small dimension in an image. Before the object moves,

$$I O U = \frac{\vert A ⋂ B \vert}{\vert A ⋃ B \vert} = 0 \text{.53} ,$$

and after the object moves,

$$I O U = \frac{\vert A ⋂ C \vert}{\vert A ⋃ C \vert} = 0 \text{.06} .$$

Thus, for small dimension objects, a slight movement of an object to be detected will result in a dramatic change in an intersection over union (IOU). On the contrary, referring to FIG. 4B, A is used as a ground truth bounding box, B and C are used as a candidate bounding box before moving and a candidate bounding box after moving, respectively, and an object to be detected is an object with a relatively large dimension in an image. Before the object moves,

$$I O U = \frac{\vert A ⋂ B \vert}{\vert A ⋃ B \vert} = 0 \text{.90} ,$$

and after the object moves,

$$I O U = \frac{\vert A ⋂ C \vert}{\vert A ⋃ C \vert} = 0.65 .$$

Thus, for large dimension objects, a slight movement of an object to be detected does not result in a large change in an IOU.

Based on this, more candidate bounding boxes (i.e., expanded candidate bounding boxes) are laid only for a region in which small objects are distributed in a driving scene image, and only basic candidate bounding boxes are laid for other regions. Thus, according to a method of object detection for driving assistance of the described techniques, a detection accuracy of a small object dense region at a far end may be improved under a condition of not increasing time consumption, in other words, a whole number of candidate bounding boxes may be reduced and a detection efficiency is improved, while a detection accuracy is ensured.

Similarly, expanded candidate bounding boxes are only laid for densely distributed regions of objects to be detected in a driving scene image, and only basic candidate bounding boxes are laid for other regions. Preferably, expanded candidate bounding boxes are laid only for regions, in which objects to be detected have dimensions smaller than a predetermined dimension threshold and a density greater than a predetermined density threshold, in a driving scene image.

With continued reference to FIG. 1, a method of object detection for driving assistance according to the described techniques further includes S190: inputting the basic candidate bounding boxes and the expanded candidate bounding boxes into an object detection model to detect an object affecting a driving behavior, and obtaining an object detection result of the driving scene image.

It should be understood that an object detection result is obtained for a driving scene image of each moment of a driving scene video, and the driving scene image of each moment may be fed back to a vehicle or a driver of a vehicle in real time. In this way, the vehicle or the driver of the vehicle makes a decision on the driving behavior according to the object detection result. Accordingly, it is possible to acquire an object detection result of a driving scene image of each moment, and thereby obtaining an object detection result of a driving scene video.

In some embodiments, a method of object detection for driving assistance according to the described techniques further includes: based on an object detection result of a driving scene image of a current moment, predicting a region of interest of a next moment, and updating the region of interest with the predicted region of interest of the next moment.

As may be seen from the foregoing steps, an initial region of interest may be obtained by inputting basic candidate bounding boxes of a driving scene image of an initial moment of a driving scene video into an object detection model. Accordingly, a region of interest of each subsequent moment of the driving scene video may be obtained according to an object detection result of a previous moment, because objects in a video object detection are continuously changed without sudden change. According to a motion rule of an object, an algorithm may predict an object dimension and density distribution of a next moment according to an object detection result of a current moment. Therefore, regions of interest of subsequent moments may be continuously determined based on an initial region of interest, and the region of interest may be updated in real time. Specifically, when a region of interest is an aforementioned small object dense region, based on a small object dense region of a current moment, a small object dense region of a next moment is predicted and the region of interest is updated with the predicted small object dense region of the next moment. Therefore, an accuracy of an algorithm in an object detection model to each region may be adjusted in real time, an algorithm with greater calculation amount and higher accuracy is used in a small object dense region, and an algorithm with lower calculation amount and moderate accuracy is used in a region with sparsely distributed objects to be detected. The region of interest is dynamically adjusted along with an object detection process of a driving scene video, namely, a region laid with expanded candidate bounding boxes in a driving scene image is dynamically adjusted, and an algorithm in an object detection model adjusts a region to apply a high-precision according to a real-time object state (such as dimension and density). In this way, a method of object detection for driving assistance according to the described techniques may achieve a real-time, dynamic adjustment of a detection accuracy of each region in a driving scene video.

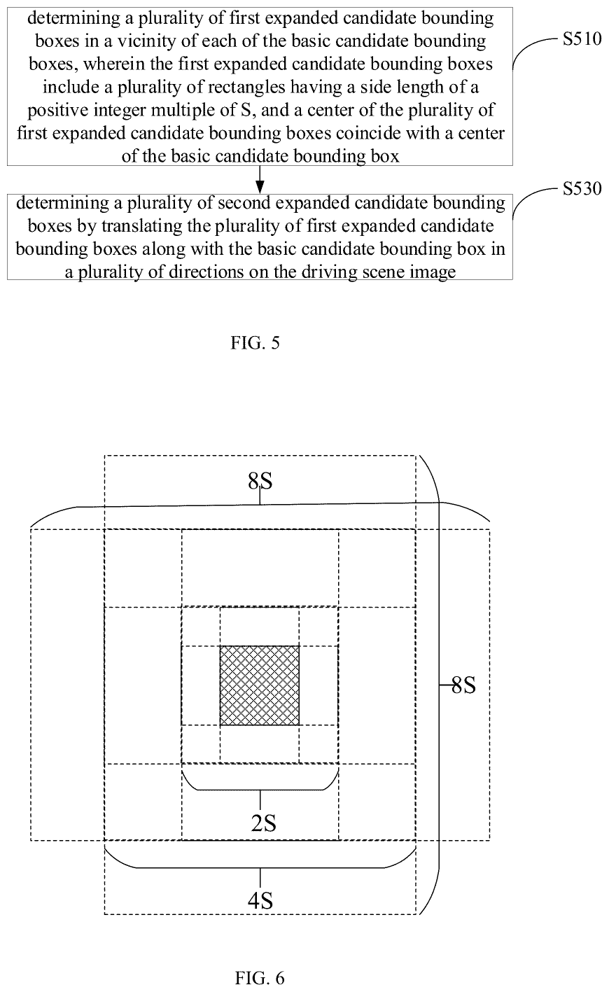

In some embodiments, further referring to FIGS. 5 to 6, the step S170 of determining the plurality of expanded candidate bounding boxes with different dimensions near each of the basic candidate bounding boxes in the region of interest, specifically includes following steps S510-S530.

S510: determining a plurality of first expanded candidate bounding boxes in a vicinity of each of the basic candidate bounding boxes, wherein the first expanded candidate bounding boxes include a plurality of rectangles having a side length of a positive integer multiple of S, and a center of the plurality of first expanded candidate bounding boxes coincides with a center of the basic candidate bounding box.

In an example shown in FIG. 6, a solid line box in the center (the shaded portion in FIG. 6) is a basic candidate bounding box, and the remaining dotted line boxes are all first expanded candidate bounding boxes. Assuming that a side length of the basic candidate bounding box is S, the first expanded candidate bounding boxes include rectangles having side lengths of 2S and 4S, respectively. Then, the side lengths of the three rectangular boxes (one basic candidate bounding box and two first expanded candidate bounding boxes) having the side lengths of S, 2S, and 4S, respectively, are subjected to stretching by 1:2, 2:1 to obtain 9 candidate bounding boxes (for example, 8 first expanded candidate bounding boxes and 1 basic candidate bounding box in the example of FIG. 6). For example, stretching a side length of a rectangular box with a side length of S in 1:2 and 2:1 will result in a rectangular box with side lengths of S×2S and 2S×S; Similarly, stretching a side length of a rectangular box with a side length of 2S in 1:2 and 2:1 will result in a rectangular box with side lengths of 2S×4S and 4S×2S, stretching a rectangular box with a side length of 4S by 1:2 and 2:1 will obtain a rectangular box with side lengths of 4S×8S and 8S×4S. In this example, these boxes with side lengths of 2S×2S, 4S×4S, S×2S, 2S×S, 2S×4S, 4S×2S, 4S×8S and 8S×4S are all first expanded candidate bounding boxes.

As is shown in FIG. 6, a center of the plurality of first expanded candidate bounding boxes coincides with a center of the basic candidate bounding box. Preferably, the plurality of first expanded candidate bounding boxes coincide with the basic candidate bounding box in symmetry axes thereof. It should be understood that a number of the first expanded candidate bounding boxes may be changed as needed, and is not limited to the number described in embodiments. In addition, a dimension of a first expanded candidate bounding box may also be changed as needed, and a side length of a first expanded candidate bounding box is not limited to 1, 2, 4, or 8 times of a side length of a basic candidate bounding box, but may be other times. It should also be understood that there are many different ways to determine a first expanded candidate bounding box, i.e., a location and a dimension of a first expanded candidate bounding box may be changed as desired, as long as the first expanded candidate bounding box is located in a vicinity of a basic candidate bounding box.

S530: by translating in a plurality of directions the plurality of first expanded candidate bounding boxes together with the basic candidate bounding box on the driving scene image, determining a plurality of second expanded candidate bounding boxes.

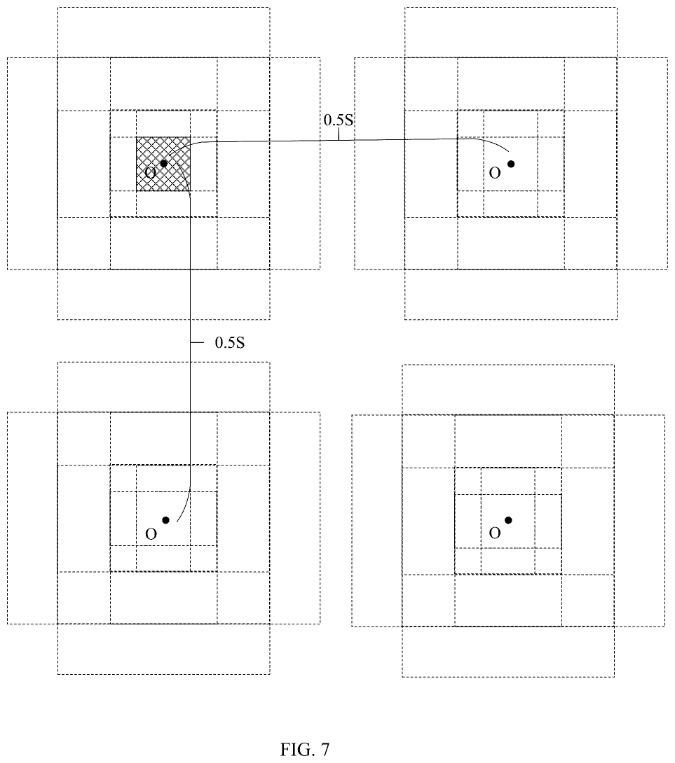

Illustratively, as is shown in FIG. 7, a side length of a basic candidate bounding box is S, one basic candidate bounding box and a plurality of first expanded candidate bounding boxes corresponding to the basic candidate bounding box and obtained as above are taken as a group of candidate bounding boxes, and the group of candidate bounding boxes are respectively translated in two side length directions perpendicular to each other by a distance of 0.5S and in a diagonal direction by a distance of

$$\frac{\sqrt{2}}{2} S ,$$

thereby obtaining three groups of translated candidate bounding boxes as second expanded candidate bounding boxes. Each group of the candidate bounding boxes has a center point O, and connecting lines between the center points O of the four groups of candidate bounding boxes obtained by the above translation will form a rectangle with a side length of 0.5S.

It should be appreciated that, in the example shown in FIG. 7, in order to avoid an overlapping of candidate bounding boxes in the schematic diagram from affecting a clarity of reading, a distance by which a candidate bounding box is translated is not illustrated in terms of an actual distance. In fact, it is preferable that each of the first expanded candidate bounding boxes and each of the second expanded candidate bounding boxes have a portion overlapping with a basic candidate bounding box.

As may be seen from the above, expanded candidate bounding boxes include first expanded candidate bounding boxes and second expanded candidate bounding boxes, that is, in the example shown in FIG. 7, rectangular boxes filled without shading are all expanded candidate bounding boxes. In the example shown in FIG. 7, 36 candidate bounding boxes in total are shown, that is, 1 basic candidate bounding box and 35 expanded candidate bounding boxes (8 first expanded candidate bounding boxes and 27 second expanded candidate bounding boxes), in other words, one basic candidate bounding box corresponds to 35 expanded candidate bounding boxes. However, the embodiment shown in FIG. 7 is merely an example, and a distance and a direction in which a group of candidate bounding boxes are translated may be changed according to actual needs, and is not limited to the distance and the direction described in the embodiment. Similarly, a number of times of translation of a group of candidate bounding boxes (a number of second expanded candidate bounding boxes obtained accordingly) may also be changed according to actual needs, and is not limited to the number of times of translation described in the embodiment.

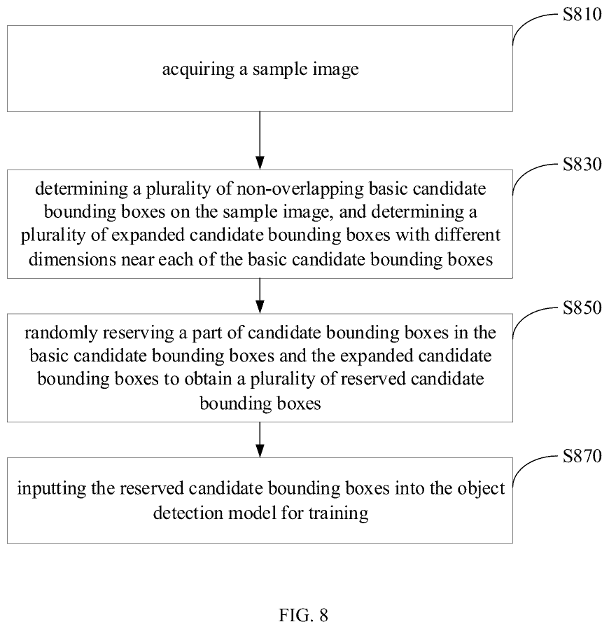

On the other hand, according to a method of object detection for driving assistance of the described techniques, before performing an object detection on a driving scene video using an object detection model, a process of training the object detection model is further included. Specifically, referring to FIG. 8, prior to inputting the basic candidate bounding boxes and the expanded candidate bounding boxes into the object detection model to detect the object affecting the driving behavior, following steps S810-S870 are further included.

S810: acquiring a sample image.

The sample image may be a previously prepared image of a driving scene, such as a road image captured by a camera.

S830: determining a plurality of non-overlapping basic candidate bounding boxes on the sample image, and determining a plurality of expanded candidate bounding boxes with different dimensions near each of the basic candidate bounding boxes.

A method of determining the basic candidate bounding boxes and the expanded candidate bounding boxes on the sample image may refer to the method of determining the basic candidate bounding boxes and the expanded candidate bounding boxes on the driving scene image to be detected in above embodiments, and details are not repeated here.

S850: randomly reserving a part of candidate bounding boxes in the basic candidate bounding boxes and the expanded candidate bounding boxes to obtain a plurality of reserved candidate bounding boxes.

In a stage of training an object detection model, a candidate bounding box determined on a sample image is designated as a positive sample if an IOU thereof with a ground truth bounding box is greater than a certain positive sample threshold, is designated as a negative sample if the IOU thereof with the ground truth bounding box is less than a certain negative sample threshold, and may be discarded if the IOU thereof with the ground truth bounding box is between the positive sample threshold and the negative sample threshold, and for some adaptive positive and negative sample allocation algorithms, a designation of a candidate bounding box as a positive sample may further need to meet more conditions.

An increase of a candidate bounding box density will increase a number of positive samples that meet conditions, so that in a stage of detection and inference by using a model, a probability that an object in an image to be detected touches a boundary of positive and negative samples is reduced. Therefore, a density and a dimension of a candidate bounding box determined on an image directly determine a degree of stability of a final detection result. However, in a stage of training an object detection model, excessively increasing candidate bounding boxes will introduce more negative samples again, resulting in a reduction in a detection accuracy and a calculation speed in a subsequent inference stage. Therefore, in a stage of training an object detection model, considerations need to be given to ensuring an accuracy and a stability degree of the object detection model.

Therefore, in order to train all candidate bounding boxes sufficiently and reduce a training difficulty, candidate bounding boxes on a sample image are randomly discarded, that is, a part of candidate bounding boxes in basic candidate bounding boxes and expanded candidate bounding boxes are randomly reserved, and the rest of the candidate bounding boxes are discarded. When the candidate bounding boxes are reserved and discarded, a randomness model of reservation or discarding is paid attention to, so that candidate bounding boxes at various locations and with various dimensions on the sample image are reserved by a certain number, thereby improving a training effectiveness.

S870: inputting the reserved candidate bounding boxes into the object detection model for training.

As is described above, when training an object detection model, using only a part of candidate bounding boxes on a sample image to train the model helps to lay more candidate bounding boxes while ensuring an accuracy of the model, so as to improve a training efficiency. It should be appreciated that a discarded candidate bounding box is neither a positive sample nor a negative sample, does not participate in training, and does not participate in a calculation of a loss function (loss). Thus, a trained object detection model is obtained. In an actual detection and inference process, performing an object detection on a driving scene image and a driving scene video by using a trained object detection model.

In some embodiments, randomly reserving the portion of the basic candidate bounding boxes and the expanded candidate bounding boxes to obtain the plurality of reserved candidate bounding boxes, includes one or more of following steps (1)-(3):

(1) randomly selecting one or more region(s) in the sample image as reserved region(s), and only reserving candidate bounding boxes located in the reserved region(s) as the reserved candidate bounding boxes.

In other words, one or more discarded region(s) may be randomly selected on a sample image, and all candidate bounding boxes located in the one or more discarded region(s) are discarded. In the sample image, the reserved region(s) and the discarded region(s) do not overlap with each other, and a sum of an area of the reserved region(s) and an area of the discard region(s) is an area of the sample image. Candidate bounding boxes located in the reserved region(s) are reserved and candidate bounding boxes located in the discarded region(s) are discarded. A candidate bounding box located in a reserved region or a discarded region may be understood as a candidate bounding box whose entire area is located in the region, or may be understood as a candidate bounding box of which only a part of the area is located in the region. It should be understood that, in the described techniques, candidate bounding boxes include basic candidate bounding boxes and expanded candidate bounding boxes.

In an embodiment, a selection of a reserved region or a discarded region is random. For example, in a process of multiple times of trainings and multiple times of selections of reserved regions or discarded regions, the reserved region(s) or the discarded region(s) selected each time are not the same.

(2) randomly reserving a certain proportion of candidate bounding boxes in all of the basic candidate bounding boxes and the expanded candidate bounding boxes as the reserved candidate bounding boxes.

Illustratively, 20%-50% of all candidate bounding boxes may be randomly discarded and 50%-80% of the candidate bounding boxes may be correspondingly reserved as reserved candidate bounding boxes. For example, when there are 2000 candidate bounding boxes (including basic candidate bounding boxes and expanded candidate bounding boxes) on a sample image, 1000-1600 candidate bounding boxes on the sample image may be randomly reserved and the remaining candidate bounding boxes are discarded.

(3) selecting a candidate bounding box of a certain dimension as the reserved candidate bounding box from the basic candidate bounding box and the expanded candidate bounding box; or selecting a candidate bounding box located at a particular location relative to the basic candidate bounding box as the reserved candidate bounding box.

Illustratively, a side length of a basic candidate bounding box is S, and S is 2^{x} (x power of 2) times of a down-sampling multiple of an object detection model, wherein x is an integer. A candidate bounding box of a particular dimension may be selected as a reserved candidate bounding box. For example, a candidate bounding box having a side length of 4S may be selected as a reserved candidate bounding box, and other candidate bounding boxes may be discarded. For example, candidate bounding boxes having dimensions of 4S×4S, 2S×4S, 4S×2S, 4S×8S, and 8S×4S are selected as reserved candidate bounding boxes. Also alternatively or additionally, an expanded candidate bounding box located at a particular location relative to a basic candidate bounding box may be selected as a reserved candidate bounding box. For example, a candidate bounding box whose center is located at a distance of 0.5S to a right side of a center of a basic candidate bounding box is taken as a reserved candidate bounding box. It may be appreciated that selections of the dimensions and locations of the candidate bounding boxes in the above examples are merely exemplary and in practice may be varied as desired.

A step of randomly reserving candidate bounding boxes includes one or more of the above steps (1)-(3), and different steps of the above steps (1)-(3) may be used in multiple times of trainings, or each of the above steps (1)-(3) may be applied in each time of training.

In this way, in a process of training an object detection model excessive candidate bounding boxes are prevented from being used for training, and meanwhile, a training efficiency and therefore a precision of the object detection model are guaranteed as much as possible.

In some embodiments, a method of object detection for driving assistance according to the described techniques further includes: increasing a convolution layer number of a feature extraction network in the object detection model.

Since a number of candidate bounding boxes inputted into an object detection model is increased, a processing amount of the object detection model is increased. In order to improve a generalization capability of the object detection model, it is advantageous to increase a feature width of the last two layers of the object detection model, that is, to correspondingly increase a number of convolution layers of a feature extraction network in the object detection model and increase a number of output channels. Therefore, a stability of an output result in a detection inference process by using the object detection model is improved.

In the above-described embodiments of a method of object detection for driving assistance, it should be understood that an order of the above-described steps is merely exemplary, and is intended for convenience of description. In practice, an order of the above steps may be changed as long as no logical contradiction occurs.

According to a method of object detection for driving assistance of the above described embodiments, for a region of interest which is a region needing a special attention in a driving scene, more candidate bounding boxes with more various dimensions are laid, so that an object detection accuracy of the region of interest is improved; meanwhile, excessive candidate bounding boxes are prevented from being added to a whole region of an image to be detected, and therefore a calculation amount of an object detection model is reduced, and an object detection speed is improved. Specifically, for a small object dense region which needs a special attention in an application of vehicle to everything, the small object dense region is detected by using a higher-precision algorithm, and the small object dense region may be dynamically adjusted in a process of detecting a driving scene video.

On the other hand, in a process of training an object detection model, in order to avoid that too many candidate bounding boxes are laid on a sample image to lead to excessive negative samples in the training process and thus to cause a detection precision reduction of the model, the candidate bounding boxes are randomly discarded while only a part thereof being reserved for training the object detection model, so that a detection stability of the object detection model may be improved, and a detection precision may be ensured at the same time.

According to another aspect of the described techniques, as is shown in FIG. 9, an apparatus 900 of object detection for driving assistance is provided, and includes an acquisition module 910, a determination module 930, and a detection module 950. The acquisition module 910 is configured for acquiring a driving assistance video of an object to be detected, and acquiring an image to be detected of each moment of the driving assistance video. The determination module 930 is configured for determining a plurality of non-overlapping basic candidate bounding boxes on the image to be detected, and determining a region of interest of the image to be detected, and determining a plurality of expanded candidate bounding boxes with different dimensions near each of the basic candidate bounding boxes in the region of interest. The detection module 950 is configured for inputting the basic candidate bounding boxes and the expanded candidate bounding boxes into an object detection model for object detection, to obtain an object detection result of the image to be detected.

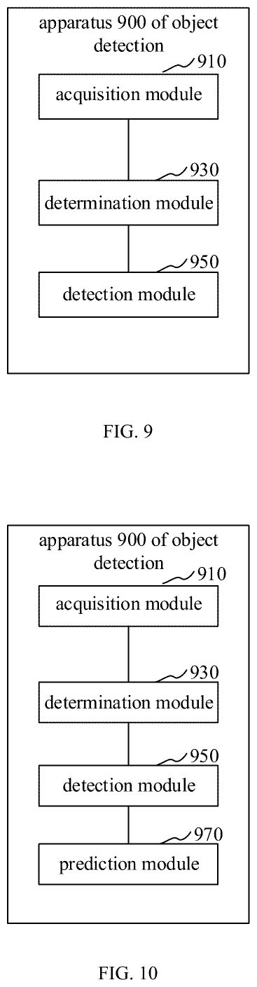

In one embodiment, as is shown in FIG. 10, the apparatus 900 of object detection further includes a prediction module 970 configured for predicting a region of interest of a next moment based on an object detection result of a driving scene image of a current moment, and updating the region of interest with the predicted region of interest of the next moment.

In an embodiment, the determination module 930 is further configured for acquiring a pre-designated region as the region of interest.

In an embodiment, the determination module 930 is further configured for determining a small object dense region in the driving scene image as the region of interest, wherein the small object dense region is a region in which the object has a dimension smaller than a predetermined dimension threshold or a density greater than a predetermined density threshold in the driving scene image. Specifically, the determination module 930 is configured for inputting basic candidate bounding boxes of the driving scene image of an initial moment of the driving scene video into the object detection model to detect the object, to obtain an object detection result of the initial moment; and determining the small object dense region as the region of interest based on the object detection result of the initial moment.

In one embodiment, the determination module 930 is further configured for: determining a square basic candidate bounding box, wherein a side length of the basic candidate bounding box is S, and S is 2^{x} times of a down-sampling multiple of the object detection model, wherein x is an integer; determining a plurality of first expanded candidate bounding boxes in a vicinity of each of the basic candidate bounding boxes, wherein the first expanded candidate bounding boxes include a plurality of rectangles having a side length of a positive integer multiple of S, and a center of the plurality of first expanded candidate bounding boxes coincides with a center of the basic candidate bounding box, and determining a plurality of second expanded candidate bounding boxes by translating the plurality of first expanded candidate bounding boxes together with the basic candidate bounding box in a plurality of directions on the driving scene image.

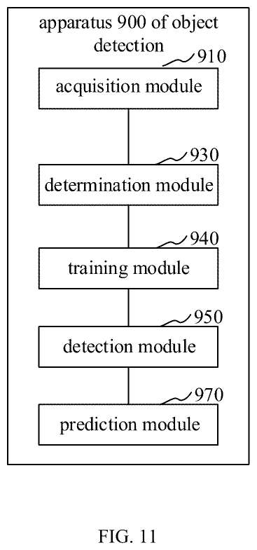

In one embodiment, as is shown in FIG. 11, the apparatus 900 of object detection further includes a training module 940, wherein the training module 940 is configured for acquiring a sample image before inputting the basic candidate bounding boxes and the expanded candidate bounding boxes into an object detection model to detect an object affecting a driving behavior; determining a plurality of non-overlapping basic candidate bounding boxes on the sample image, and determining a plurality of expanded candidate bounding boxes with different dimensions near each of the basic candidate bounding boxes; randomly reserving a part of candidate bounding boxes in the basic candidate bounding boxes and the expanded candidate bounding boxes to obtain a plurality of reserved candidate bounding boxes; and inputting the reserved candidate bounding boxes into the object detection model for training.

In an embodiment, a training module 940 is further configured to implement one or more of following steps: randomly selecting one or more region(s) in the sample image as reserved region(s), and reserving only candidate bounding boxes located in the reserved region(s) as the reserved candidate bounding boxes; randomly reserving a certain proportion of candidate bounding boxes in all of the basic candidate bounding boxes and the expanded candidate bounding boxes as the reserved candidate bounding boxes; and selecting a candidate bounding box of a certain dimension as the reserved candidate bounding box from the basic candidate bounding box and the expanded candidate bounding box; or selecting a candidate bounding box located at a particular location relative to the basic candidate bounding box as the reserved candidate bounding box.

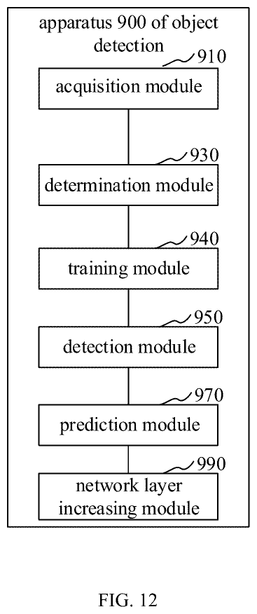

In one embodiment, as is shown in FIG. 12, an apparatus 900 of object detection further includes a network layer increasing module 990, configured for increasing a number of convolution layers of a feature extraction network in the object detection model.

An apparatus of object detection for driving assistance of this application and a method of object detection for driving assistance of this application are in one-to-one correspondence, technical features and beneficial effects thereof described in the above embodiments of the method of object detection for driving assistance are applicable to embodiments of the apparatus of object detection for driving assistance, and it is hereby declared.

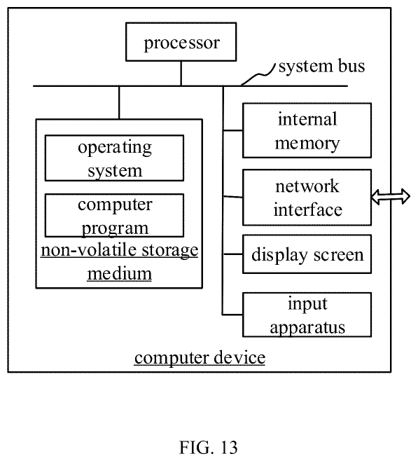

According to another aspect of the described techniques, there is provided a computer device, which may be a terminal, and may have an internal structure diagram as is shown in FIG. 13. The computer device includes a processor, a memory, a network interface, a display screen, and an input apparatus connected by a system bus. The processor of the computer device is configured to provide computing and control capabilities. The memory of the computer device comprises a non-volatile storage medium and an internal memory. The non-volatile storage medium stores an operating system and a computer program. The internal memory provides an environment for the operation of the operating system and the computer program in the non-volatile storage medium. The network interface of the computer device is used for communicating with an external terminal through a network connection. The computer program is executed by a processor to implement the method of object detection for driving assistance according to the above-described embodiments. The display screen of the computer device may be a liquid crystal display screen or an electronic ink display screen, and the input apparatus of the computer device may be a touch layer covered on the display screen, or a key, a track ball or a touch pad arranged on a shell of the computer device, or an external keyboard, touch pad or mouse and the like.

It may be appreciated by those skilled in the art that the configuration shown in FIG. 13 is a block diagram of only a portion of the configuration associated with the described techniques, and is not intended to limit the computer device to which the described techniques can be applied, and that a particular computer device may include components more or less than shown in the figure, or may combine certain components, or may have a different arrangement of components.

In an embodiment, a computer device is further provided, and includes a memory and a processor, the memory stores a computer program therein, and the processor implements steps of the above embodiments of the method when executing the computer program.

According to yet another aspect of the described techniques, a computer-readable storage medium is provided, and stores thereon a computer program, which, when being executed by a processor, implements steps of the above-mentioned method embodiments.

It may be understood by those skilled in the art that all or part of processes of the methods of the embodiments described above may be implemented by hardware relevant to instructions of a computer program, which may be stored in a non-volatile computer-readable storage medium, and when executed, may include processes of the embodiments of the methods described above. Any reference to a memory, a storage, a database, or other medium used in the embodiments provided in this application may include a non-volatile and/or volatile memory. A non-volatile memory may include a read-only memory (ROM), a programmable ROM (PROM), an electrically programmable ROM (EPROM), an electrically erasable programmable ROM (EEPROM), or a flash memory. A volatile memory may include a random access memory (RAM) or an external cache memory. By way of illustration and not limitation, an RAM is available in a variety of forms such as a static RAM (SRAM), a dynamic RAM (DRAM), a synchronous DRAM (SDRAM), a double data rate SDRAM (DDRSDRAM), an enhanced SDRAM (ESDRAM), a synchronous link (Synchlink) DRAM (SLDRAM), a rambus (Rambus) direct RAM (RDRAM), a direct rambus dynamic RAM (DRDRAM), and a rambus dynamic RAM (RDRAM), among others.

Various technical features of the above embodiments may be arbitrarily combined, and for the sake of brevity, not all possible combinations of the technical features in the above embodiments are described. However, as long as there is no contradiction in the combinations of these technical features, they should be considered as the scope of the present specification.

The above-mentioned embodiments only express several embodiments of the described techniques, and the description thereof is relatively specific and detailed, but should not be construed to limit the scope of the application. It should be noted that, for a person skilled in the art, without departing from the concept of the described techniques, several variations and modifications may also be made, and fall within the scope of protection of the described techniques. Therefore, the protection scope of the described techniques shall be subject to the appended claims.

What is claimed is:

1. A method of object detection for driving assistance, comprising:
acquiring a driving scene video, and acquiring a driving scene image of each moment of the driving scene video;
determining a plurality of non-overlapping basic candidate bounding boxes on the driving scene image;
determining a region of interest in the driving scene image;
determining a plurality of expanded candidate bounding boxes with different dimensions for each of the basic candidate bounding boxes in the region of interest; and
inputting the basic candidate bounding boxes and the expanded candidate bounding boxes into an object detection model to detect an object that would affect a driving behavior, and obtaining an object detection result of the driving scene image.

2. The method according to claim 1, further comprising:
predicting a region of interest of a next moment based on an object detection result of a driving scene image of a current moment, and updating the region of interest with the predicted region of interest of the next moment.

3. The method according to claim 1, wherein determining the region of interest of the driving scene image comprises:
acquiring a pre-designated region as the region of interest.

4. The method according to claim 1, wherein determining the region of interest of the driving scene image comprises:
determining an object dense region in the driving scene image as the region of interest, wherein the object dense region is a region that represents an object that has a dimension smaller than a predetermined dimension threshold or having a density of objects greater than a predetermined density threshold in the driving scene image.

5. The method according to claim 4, wherein determining the object dense region in the driving scene image as the region of interest comprises:
inputting basic candidate bounding boxes of the driving scene image of an initial moment of the driving scene video into the object detection model to detect the object, and generating an object detection result of the initial moment using the basic candidate bounding boxes; and
determining the object dense region as the region of interest based on the object detection result of the initial moment.

6. The method according to claim 1, wherein determining the plurality of non-overlapping basic candidate bounding boxes on the driving scene image comprises:
determining a square basic candidate bounding box, wherein a side length of the basic candidate bounding box is S, and S is represented by 2^{x} times of a down-sampling multiple of the object detection model, wherein x is an integer; and
determining the plurality of expanded candidate bounding boxes with different dimensions for each of the basic candidate bounding boxes in the region of interest includes:
determining a plurality of first expanded candidate bounding boxes for each of the basic candidate bounding boxes, wherein the plurality of first expanded candidate bounding boxes include a plurality of rectangles with a side length of positive integer times of S, each having a center coinciding with a center of the basic candidate bounding box, and
determining a plurality of second expanded candidate bounding boxes by translating the plurality of first expanded candidate bounding boxes along with the basic candidate bounding box in a plurality of directions on the driving scene image.

7. The method according to claim 1, prior to inputting the basic candidate bounding boxes and the expanded candidate bounding boxes into the object detection model to detect the object that would affect the driving behavior, further comprising:
acquiring a sample image;
determining a plurality of non-overlapping basic candidate bounding boxes on the sample image, and determining a plurality of expanded candidate bounding boxes with different dimensions for each of the basic candidate bounding boxes;
randomly reserving a part of candidate bounding boxes in the basic candidate bounding boxes and the expanded candidate bounding boxes to obtain a plurality of reserved candidate bounding boxes; and
inputting the reserved candidate bounding boxes into the object detection model for training.

8. The method according to claim 7, wherein determining the plurality of non-overlapping basic candidate bounding boxes on the sample image, and determining the plurality of expanded candidate bounding boxes with different dimensions for each of the basic candidate bounding boxes, comprises:
determining a square basic candidate bounding box, wherein a side length of the basic candidate bounding box is S, and S is 2^{x} times of a down-sampling multiple of the object detection model, wherein x is an integer;
determining, for each of the basic candidate bounding boxes, a plurality of first expanded candidate bounding boxes each at least partially overlapping the basic candidate bounding box, wherein the first expanded candidate bounding boxes include a plurality of rectangles having a side length of a positive integer multiple of S, and
determining a plurality of second expanded candidate bounding boxes by translating the plurality of first expanded candidate bounding boxes along with the basic candidate bounding box in a plurality of directions on the sample image.

9. The method according to claim 7, wherein randomly reserving the part of candidate bounding boxes in the basic candidate bounding boxes and the expanded candidate bounding boxes to obtain the plurality of reserved candidate bounding boxes, comprises one or more of following steps:
randomly selecting one or more regions in the sample image as reserved regions, and reserving candidate bounding boxes that are located in the reserved regions as the plurality of reserved candidate bounding boxes;
randomly reserving a certain proportion of candidate bounding boxes in all of the basic candidate bounding boxes and the expanded candidate bounding boxes as the plurality of reserved candidate bounding boxes;
selecting one or more candidate bounding boxes of a certain dimension as the plurality of reserved candidate bounding boxes from the basic candidate bounding boxes and the expanded candidate bounding boxes; or
selecting one or more candidate bounding boxes located at a particular location relative to one of the basic candidate bounding boxes as the plurality of reserved candidate bounding boxes.

10. The method according to claim 7, further comprising:
increasing a number of feature extraction operations in a convolution layer in the object detection model.

11. (canceled)

12. A device comprising a memory and a processor, the memory storing one or more instructions that, once executed by the processor, cause the processor to perform operations, the operations comprising:
acquiring a driving scene video, and acquiring a driving scene image of each moment of the driving scene video;
determining a plurality of non-overlapping basic candidate bounding boxes on the driving scene image;
determining a region of interest in the driving scene image;
determining a plurality of expanded candidate bounding boxes with different dimensions for each of the basic candidate bounding boxes in the region of interest; and
inputting the basic candidate bounding boxes and the expanded candidate bounding boxes into an object detection model to detect an object that would affect a driving behavior, and obtaining an object detection result of the driving scene image.

13. One or more computer-readable storage media, storing thereon one or more instructions that, once executed by one or more processors, cause the one or more processors to perform operations, the operations comprising:
acquiring a driving scene video, and acquiring a driving scene image of each moment of the driving scene video;
determining a plurality of non-overlapping basic candidate bounding boxes on the driving scene image;
determining a region of interest in the driving scene image;
determining a plurality of expanded candidate bounding boxes with different dimensions for each of the basic candidate bounding boxes in the region of interest; and
inputting the basic candidate bounding boxes and the expanded candidate bounding boxes into an object detection model to detect an object that would affect a driving behavior, and obtaining an object detection result of the driving scene image.

14. The device according to claim 12, wherein the operations further comprise:
predicting a region of interest of a next moment based on an object detection result of a driving scene image of a current moment, and updating the region of interest with the predicted region of interest of the next moment.

15. The device according to claim 12, wherein determining the region of interest of the driving scene image comprises:
acquiring a pre-designated region as the region of interest.

16. The device according to claim 12, wherein determining the region of interest of the driving scene image comprises:
determining an object dense region in the driving scene image as the region of interest, wherein the object dense region is a region that represents an object that has a dimension smaller than a predetermined dimension threshold or having a density of objects greater than a predetermined density threshold in the driving scene image.

17. The device according to claim 16, wherein determining the object dense region in the driving scene image as the region of interest comprises:
inputting basic candidate bounding boxes of the driving scene image of an initial moment of the driving scene video into the object detection model to detect the object, and generating an object detection result of the initial moment using the basic candidate bounding boxes; and
determining the object dense region as the region of interest based on the object detection result of the initial moment.

18. The one or more computer-readable storage media according to claim 13, wherein the operations further comprise:
predicting a region of interest of a next moment based on an object detection result of a driving scene image of a current moment, and updating the region of interest with the predicted region of interest of the next moment.

19. The one or more computer-readable storage media according to claim 13, wherein determining the region of interest of the driving scene image comprises:
acquiring a pre-designated region as the region of interest.

20. The one or more computer-readable storage media according to claim 13, wherein determining the region of interest of the driving scene image comprises:
determining an object dense region in the driving scene image as the region of interest, wherein the object dense region is a region that represents an object that has a dimension smaller than a predetermined dimension threshold or having a density of objects greater than a predetermined density threshold in the driving scene image.

21. The one or more computer-readable storage media according to claim 20, wherein determining the object dense region in the driving scene image as the region of interest comprises:
inputting basic candidate bounding boxes of the driving scene image of an initial moment of the driving scene video into the object detection model to detect the object, and generating an object detection result of the initial moment using the basic candidate bounding boxes; and
determining the object dense region as the region of interest based on the object detection result of the initial moment.
